(19) United States
(12) Patent Application Publication
(10) Pub. No.: US 2023/0122477 A1
(43) Pub. Date: Apr. 20, 2023

(54) METHOD OF DETERMINING AN INDUCTION COOKTOP GAIN AND RELATED METHOD OF REGULATING A COOKING PROCESS

(71) Applicant: WHIRLPOOL CORPORATION, BENTON HARBOR, MI (US)

(72) Inventors: Andrea Gasparoni, Comerio (IT); Daniele Masi, Travedona Monate (IT); Davide Parachini, Cassano Magnago (IT); Collin A. Stipe, West Unity, OH (US)

(73) Assignee: WHIRLPOOL CORPORATION, BENTON HARBOR, MI (US)

(21) Appl. No.: 17/504,709

(22) Filed: Oct. 19, 2021

(51) Int. Cl. H05B 6/06

(52) U.S. Cl. CPC H05B 6/062; H05B 2213/07; H05B 2213/05

(57) ABSTRACT

A method for estimating a temperature measurement of an item of cookware being heated is provided. The method includes (1) placing a cookware item containing water, on a cooking plate; (2) powering an electric heating circuit with a first power for a first time interval to heat the cookware item as far as the water contained therein boils, wherein said first time interval is determined so as said temperature sensor senses a first steady state temperature value; (3) powering said electric heating circuit with a second power for a second time interval to heat the cookware item to keep boiling the water contained therein, wherein said second time interval is determined so as said temperature sensor attains a second steady state temperature value; and (4) determining, as a function of said first steady state temperature value and of said second steady state temperature value, an induction cooktop gain.

### TECHNICAL FIELD

This disclosure relates to a method for determining an induction cooktop gain associated with an item of cookware, placed on a glass cooktop plate, and a related method of regulating a cooking process using an induction cooktop and an item of cookware.

### BACKGROUND

In professional food preparation, the temperature and the temperature control considerably influence the quality of prepared foods. Therefore, an optimal temperature control during heating of food to be cooked is very important.

An optimal and, in particular, also a regulated temperature control, however, is only obtainable when the cooking device can detect the temperature state of the bottom of the cooking utensil or pan as precisely as possible, without time delay and as continuously as possible during the cooking process. In conventional thermal cooking zones on cooktops, the continuous detection or acquisition of the temperature of the bottom of the cooking pan is not known and the temperature control is based on the user's experience.

It is basically possible to introduce temperature sensors underneath the cooking plate, which is usually a ceramic or glass panel and which serves as a support for the cooking pan. These temperature sensors measure the absolute temperature of the underside of the cooking item. The measured temperature values, however, deviate to a greater or lesser extent from the actual temperature of the bottom of the cooking pan, depending on the thickness and the heat conductivity of the cooking support, as well as the dynamics of the cooking process relative to the temperature control. Therefore, the measured temperature values do not correspond to the temperature of the pan bottom in certain phases of the cooking process, in particular, during the heating of the bottom of the cooking pan. A measuring of the temperature of the bottom of the cooking pan in real time is considered almost impossible.

This problem is also present in induction cooking devices, since here, in contrast to thermal cooking devices, the cooking pan is heated directly. The product to be cooked is heated in turn indirectly by the heated cooking item, but with a certain time delay. The cooking support here, in contrast to a thermal cooking device, is not directly heated, but is heated only indirectly by thermal feedback or reflection of the cooking pan. A control of temperature exclusively by measuring the temperature of the cooking support by means of the named temperature sensors is presently not considered suitable for accurately controlling cooking of food.

Temperature control on induction cooktops is known, but most of the time the variability of working conditions (cookware/load) makes temperature control so coarse that the temperature control benefit is greatly reduced.

The oldest (and cheapest) way to achieve a kind of temperature control, is to use the temperature measurement taken by the always present temperature sensor placed underneath the glass of the cooking plate, in the centre of the inductor which generates the magnetic field heating the cooking vessel. Such arrangement allows a certain degree of temperature control, whose performances are affected by the characteristics of the pan and of the load.

Some drawbacks of the above solution can be overcome with a different arrangement of the temperature sensor that, in some implementations, is protruding out of the glass of the cooking plate, so to touch the bottom of the cooking vessel. Such a solution brings a higher temperature measurement fidelity, but requires the glass to be drilled, while maintaining sealing between glass and sensor assembly, to avoid liquid leaking inside the cooktop, and leaving the sensor, usually spring loaded, free to move vertically to adapt to the cookware bottom.

A further disadvantage is that the cleanability of the cooktop is greatly reduced, because of the sensor assemblies protruding out of the cooking plate.

Another solution is to use an infrared sensor, installed inside the cooktop, in the inductor assembly or in its close vicinity, to measure the temperature of the cookware bottom from beneath the glass. While the use of infrared sensors avoid having holes and assembly protruding out of the glass impacting the cleanability of the cooktop, their cost is much higher than that of usual contact temperature sensors, the presence of the glass in the optical path affects the measurement as well as the emissivity of the cookware bottom. Cooktop manufacturers following this approach put in place countermeasures to compensate for both effects, but this further increases the cost of the solution.

The document US2014158678 discloses a method of determining the temperature of a cooking item placed onto an induction cooking device, implemented using the arrangement shown in FIG. 1. An induction cooking device 1 comprises an induction coil 3 disposed underneath a glass-ceramic cooking plate 2 for the heating of an item of cookware 5, such as a pan and its contents 6 above the pan. A temperature sensor 4 for measuring the temperature of the glass-ceramic cooking plate 2 is disposed on that side of the glass-ceramic cooking plate 2 facing the induction coil.

The method above is implemented using also measures obtained from the measuring coil 7 for the measurement of the resonant frequency, disposed underneath the glass-ceramic cooking plate 2 in the region of the induction coil 3.

The document EP2094059 shows the induction hob of FIG. 2, having an induction heating element 10, which is arranged under a cooking plate 32 of the induction hob, a cover plate 32 made of glass or glass ceramic, wherein a temperature sensor 12 for indirectly measuring a temperature of an item of cookware 18 is arranged under the cooking plate 32 in the area of the induction heating element 10. The induction heating element 10 and the temperature sensor 12 are connected to a control unit 16 of the induction hob, which operates the induction heating element 10 and can read out the measurement data from the temperature sensor 12.

According to EP2094059, the induction cooking hob is operated by identifying the item of cookware 18 by means of at least one characteristic electric variable of the item of cookware 18, and a cooking temperature of the item of cookware 18 is determined using both the temperature measured by the temperature sensor 14 and at least one specific thermal parameter for the item of cookware 18, wherein an at least partly-automated calibration program must be executed for determining the thermal parameter and for assigning the thermal parameter to the characteristic electric variable.

A simpler method for determining the temperature of an item of cookware heated by an induction cooking hob would be desirable.

### SUMMARY

A method of determining an induction cooktop gain associated with an item of cookware has been found, which can estimate a temperature of the item of cookware while being heated using only a temperature sensor placed underneath the glass cooking plate. The method may be implemented in an induction cooktop, wherein the induction cooktop includes a cooking plate on which an item of cookware to be heated is placed, an electric heating circuit for induction heating of said item of cookware, said electric circuit being placed underneath said cooking plate, and a temperature sensor placed underneath said cooking plate.

The induction cooktop gain is determined as the ratio between a difference between an external temperature of said item of cookware and a reference temperature, and a difference between a temperature sensed by said temperature sensor at a present time and said reference temperature.

In at least one aspect, a method of determining at least one induction cooktop characteristic, includes a method wherein the induction cooktop comprises: (1) a cooking plate on which an item of cookware to be heated is placed; (2) an electric heating circuit for induction heating of said item of cookware, said electric circuit being placed underneath said cooking plate; and (3) a temperature sensor placed underneath said cooking plate, wherein said at least one induction cooktop characteristic comprises an induction cooktop gain as the ratio between a difference between an external temperature of said item of cookware and a reference temperature, and a difference between a temperature sensed by said temperature sensor at a present time and said reference temperature. Using the induction cooktop above, the method includes the following steps: (1) placing said item of cookware, filled at least partially with water, on said cooking plate; (2) powering said electric heating circuit with a first power for a first time interval to heat by induction said item of cookware as far as the water contained therein boils, wherein said first time interval is determined so as said temperature sensor senses a first steady state temperature value; (3) after said first time interval, powering said electric heating circuit with a second power for a second time interval heating by induction said item of cookware to keep boiling the water contained therein, wherein said second time interval is determined so as said temperature sensor attains a second steady state temperature value; and (4) determining, as a function of said first steady state temperature value and of said second steady state temperature value, said induction cooktop gain.

According to another aspect of the disclosure, a method of determining an induction cooktop gain includes the steps of: (1) providing an induction cooktop having a cooking plate on which an item of cookware to be heated is placed, wherein the induction cooktop further includes an electric heating circuit disposed underneath said cooking plate for induction heating of said item of cookware, and further wherein the induction cooktop include a temperature sensor placed underneath said cooking plate, wherein the induction cooktop gain is determined as the ratio between a difference between an external temperature of said item of cookware and a reference temperature, and a difference between a temperature sensed by said temperature sensor at a present time and said reference temperature; (2) placing said item of cookware on said cooking plate, wherein said item of cookware includes a volume of water; (3) powering said electric heating circuit with a first power level for a first time interval to heat said item of cookware until the water boils, wherein said first time interval is determined so as said temperature sensor senses a first steady state temperature value; (4) after said first time interval, powering said electric heating circuit with a second power level for a second time interval to heat said item of cookware to keep the water in a boiling condition, wherein said second time interval is determined so as said temperature sensor attains a second steady state temperature value; and (5) determining, as a function of said first steady state temperature value and of said second steady state temperature value, said induction cooktop gain.

According to another aspect of the disclosure, a method of regulating a cooking process using an induction cooktop and an item of cookware is provided, wherein the induction cooktop comprises: (1) a cooking plate on which an item of cookware to be heated is placed upon; (2) an electric heating circuit for induction heating of said item of cookware, said electric circuit being placed underneath said cooking plate; and (3) a temperature sensor placed underneath said cooking plate. The method includes the following method steps: (1) placing said item of cookware on said cooking plate, wherein said item of cookware includes a volume of water; (2) powering said electric heating circuit with a first power level for a first time interval to heat said item of cookware until the water boils, wherein said first time interval is determined so as said temperature sensor senses a first steady state temperature value; (3) after said first time interval, powering said electric heating circuit with a second power level for a second time interval to heat said item of cookware to keep the water in a boiling condition, wherein said second time interval is determined so as said temperature sensor attains a second steady state temperature value; and (4) calculating, as a function of said first steady state temperature value and of said second steady state temperature value, a calculated induction cooktop gain; and (5) conducting said cooking process by estimating a temperature on an external surface of said item of cookware using said calculated induction cooktop gain and a sensed temperature by said temperature sensor.

A method of regulating a cooking process using an induction cooktop and an item of cookware is also disclosed herein.

### BRIEF DESCRIPTION OF THE DRAWINGS

FIG. 1 depicts an induction cooktop comprising an induction coil disposed underneath a glass-ceramic cooking plate for heating an item of cookware.

FIG. 2 shows an induction hob with an induction coil, a temperature sensor and an item of cookware to be heated.

FIG. 3 is an exemplary time diagram of heating power to be supplied to an item of cookware filled with water according to the method of this disclosure.

FIG. 4 is an exemplary time diagram of temperatures in an induction cooktop of FIG. 1 when implementing the method of this disclosure.

### DESCRIPTION

The present illustrated embodiments reside primarily in combinations of method steps and apparatus components related to a method for determining a temperature of an item of cookware heated by an induction cooking hob. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

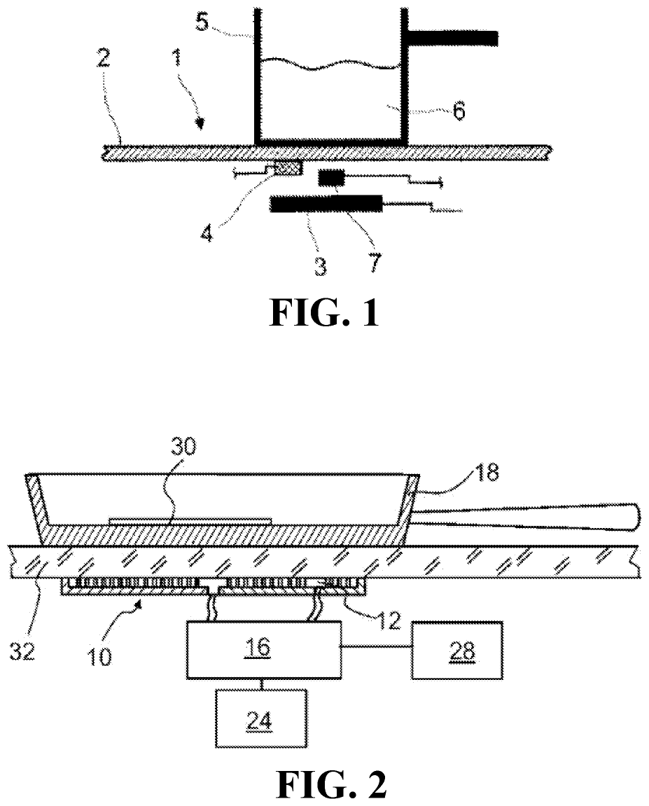

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

The terms “substantial,” “substantially,” and variations thereof, as used herein, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

The method of this disclosure can be applied to the well-known induction cooktop of FIG. 1, allowing to measure temperature of an item of cookware using only one contact temperature sensor placed underneath the glass cooking plate.

The main purpose of the temperature sensor installed in all induction cooktops is to protect the cooking vessel from overheating, so preventing oil ignition, and this is intended to be a safety function that is satisfied thanks to a dedicated calibration of the safety threshold in the normative test conditions. Indeed, temperature measured by the sensor depends by a number of parameters and it can be even 50° C. away from the temperature of the item of cookware being heated.

According to the method of this disclosure, it is possible to determine a relationship between the temperature measured by the temperature sensor and a temperature of the item of cookware being heated, thus allowing to estimate the temperature of the item of cookware using only the temperature measured by the temperature sensor.

The method of this disclosure is applied to an induction cooktop that includes a cooking plate on which an item of cookware to be heated is placed, an electric heating circuit for induction heating of the item of cookware, the electric circuit being placed underneath the cooking plate, and a temperature sensor placed underneath the cooking plate.

The method is aimed to determine an induction cooktop gain as the ratio between: a difference between an external temperature of the item of cookware and a reference temperature, and a difference between a temperature sensed by the temperature sensor at a present time and the reference temperature. According to this disclosure, the method comprises the following steps: (1) placing the item of cookware on the cooking plate, wherein the item of cookware is filled at least partially with a volume of water; (2) powering the electric heating circuit at a first power level Q1 for a first time interval t1 to heat the item of cookware by induction until the water contained therein boils, wherein the first time interval t1 is determined so as the temperature sensor senses a first steady state temperature value T1; (3) after the first time interval t1, powering the electric heating circuit at a second power level Q2 for a second time interval t2 to heat the item of cookware by induction to keep the water contained therein boiling, wherein the second time interval t2 is determined so as the temperature sensor attains a second steady state temperature value T2; (4) determining the induction cooktop gain as a function of the first steady state temperature value T1 and of the second steady state temperature value T2.

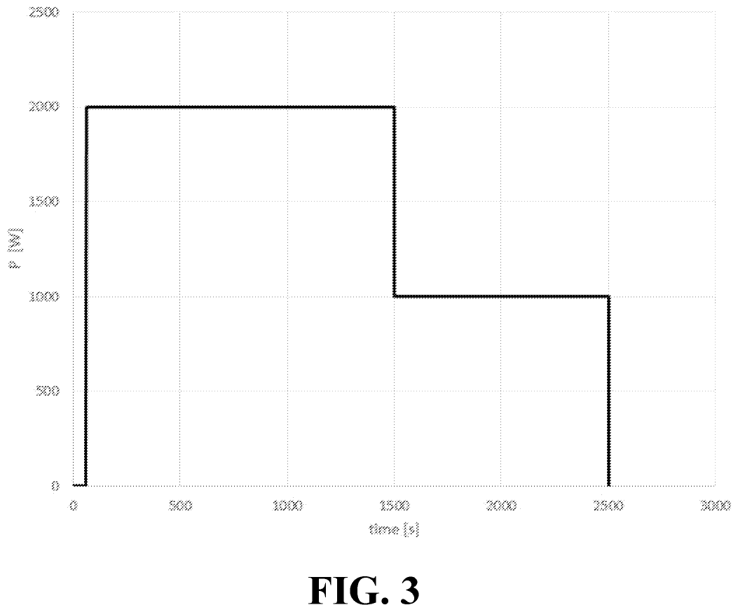

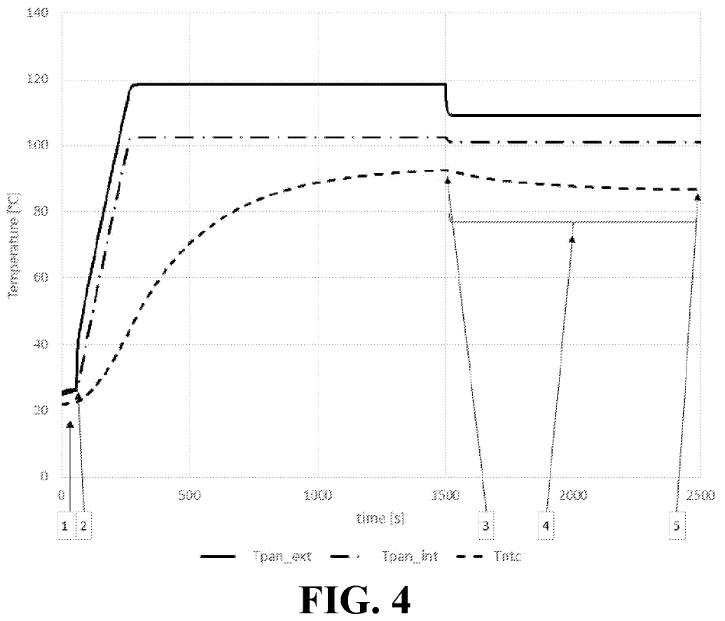

In order to understand how the abovementioned method allows one to determine the induction cooktop gain, reference may be made to the time diagrams of FIGS. 3 and 4, referring to the particular case in which the second power level Q2 is one half of the first power level Q1, in order to improve accuracy. It is noted that it may be sufficient to have the second power level Q2 be different from the first power level Q1, as opposed to the second power level Q2 being one half of the first power level Q1.

In the equations noted below, the following symbols have the following values associated therewith:

Tr: reference temperature, which may be the environment temperature;

Q1: thermal power provided during phase 1;

T1: steady-state temperature measured by the temperature sensor at the end of phase 1;

Text1: steady-state external temperature of the item of cookware at the end of phase 1;

Tint1: steady-state inner temperature of the item of cookware at the end of phase 1;

Q2: thermal power provided during phase 2;

T2: steady-state temperature measured by the temperature sensor at the end of phase 2;

Text2: steady-state external temperature of the item of cookware at the end of phase 2;

Tint2: steady-state inner temperature of the item of cookware at the end of phase 2;

K: proportionality factor;

G: induction cooktop gain to be determined;

it is possible to state that, at the end of phase 1 in steady-state conditions,

Q1=K*(Text1−Tint1). (1)

It is assumed that, when the external temperature of the item of cookware being heated rises from the reference temperature to the temperature Text1, the temperature sensor installed underneath the glass cooking plate rises from the reference temperature up to temperature T1:

(Text1−Tr)=G*(T1−Tr). (2)

Analogous equations may be written at the end of phase 2 in steady-state conditions:

Q2=K*(Text2−Tint2); (3)

(Text2−Tr)=G*(T2−Tr). (4)

Given that the item of cookware is filled with water in a boiling condition, the steady-state inner temperatures Tint1 and Tint2 are equal to each other and equal to the temperature at which water boils. It is possible to demonstrate that the gain G may be calculated using the following equation:

G*(T2−Tr)/Q2=(Tint2−Tr)/Q2+G*(T1−T2)/(Q1−Q2). (5)

In the time diagram of FIG. 4, the steady-state temperature T1 is taken at point 3; the steady-state temperature T2 is taken at point 5; and the time duration of phase 2 is the interval 4.

With reference to equation (5), it is clear that the power level Q2 may be even greater than the power level Q1. Given that water is in a boiling condition at the end of phase 1, it seems preferable to use a smaller power level Q2 in order to prevent a situation in which too much water has evaporated at the end of phase 2, when the temperature T2 is taken.

According to one aspect, the procedure for determining the induction cooktop gain may be activated either through a HMI (Human Machine Interface) or through an app running on a wirelessly connected device.

Once the induction cooktop gain G has been determined, the calculated induction cooktop gain value can be stored and can be used to estimate the external temperature of the item of cookware independently of what is being cooked, in a reliable and robust fashion, using only the temperature measured by the temperature sensor. In practice, the induction cooktop will be “calibrated” on the item of cookware to be heated. When a user starts a cooking session with an item of cookware for which the induction cookware gain has been determined, they have to associate such an item of cookware with the cooking zone to be used, either by means of a connected app, or on the cooktop HMI.

According to an aspect, it is also possible to determine a temperature sensor response time constant Tau that characterized temperature variations of the thermal sensor. The steady-state inner temperature of the item of cookware at the end of phase 1 and at the end of phase 2 is the same. Thus, when the thermal power is varied from Q1 to Q2, the temperature sensed by the thermal sensor at steady-state must vary by T2-T1, which will be either a temperature decrease if the thermal power level Q2 is less than the thermal power level Q1, or will be a temperature increase if the thermal power level Q2 is greater than the thermal power level Q1. Given that the temperature measured by the thermal sensor substantially varies according to a first degree linear differential equation, it is possible to calculate a temperature sensor response time constant Tau by fitting samples Ts(t) at time “t” of the temperature sensed by the temperature sensor in the time interval 4, lasting from the instant in which the thermal power is switched from Q1 to Q2 up to the instant 5 in which a steady-state condition is attained, into an exponential decay/rise time function. This function starts from the first steady state temperature value T1 and attaining the second steady state temperature value T2 according to the temperature sensor response time constant Tau, such as the following exponential equation:

Ts(t)=T2+(T1−T2)*exp(−t/Tau).

The temperature response time constant Tau may be obtained through a best-fit procedure, or by estimating the time derivative of the temperature sensed by the thermal sensor at the instant in which the thermal power is modified from Q1 to Q2 (instant 3 in FIG. 4), that time derivative is the ratio between the temperature difference T2-T1 and the time constant Tau, or yet using one of the well-known mathematical techniques for estimating an unknown parameter in a time-dependent equation from a collection of samples.

Once the induction cooktop gain G and the temperature sensor response time constant Tau are estimated, according to an aspect it is possible to estimate also the thermal capacitance C of the item of cookware heated by the induction cooktop. When the parameters G and Tau are determined, the external temperature Text of the item of cookware may be estimated. Assuming that when power is turned on (time instant 2 in FIG. 4) only a negligible fraction of the supplied thermal power is provided to the heated water, then the increase of the external temperature Text is substantially linear and the time derivative of the external temperature Text of the item of cookware is given by the ratio between the supplied thermal power level Q1 and the thermal capacitance C of the item of cookware.

Therefore, it is possible to implement a method of or regulating a cooking process using an induction cooktop and an item of cookware, through the following method steps: (1) preliminarily determining an induction cooktop gain by performing the above disclosed method for determining the induction cooktop gain; (2) then conducting the cooking process by estimating a temperature on an external surface of the item of cookware only depending upon the induction cooktop gain and a sensed temperature by the temperature sensor installed underneath the induction cooktop surface.

In at least one aspect, a method of determining at least one induction cooktop characteristic, includes a method wherein the induction cooktop comprises: (1) a cooking plate on which an item of cookware to be heated is placed; (2) an electric heating circuit for induction heating of said item of cookware, said electric circuit being placed underneath said cooking plate; and (3) a temperature sensor placed underneath said cooking plate, wherein said at least one induction cooktop characteristic comprises an induction cooktop gain as the ratio between a difference between an external temperature of said item of cookware and a reference temperature, and a difference between a temperature sensed by said temperature sensor at a present time and said reference temperature. Using the induction cooktop above, the method includes the following steps: (1) placing said item of cookware, filled at least partially with water, on said cooking plate; (2) powering said electric heating circuit with a first power for a first time interval to heat by induction said item of cookware as far as the water contained therein boils, wherein said first time interval is determined so as said temperature sensor senses a first steady state temperature value; (3) after said first time interval, powering said electric heating circuit with a second power for a second time interval heating by induction said item of cookware to keep boiling the water contained therein, wherein said second time interval is determined so as said temperature sensor attains a second steady state temperature value; and (4) determining, as a function of said first steady state temperature value and of said second steady state temperature value, said induction cooktop gain.

According to another aspect of the disclosure, said second power is less than said first power.

According to another aspect of the disclosure, said second power is one half of said first power.

According to another aspect of the disclosure, said at least one induction cooktop characteristic further comprises a temperature sensor response time constant, said method further comprising the steps of: (1) collecting samples of temperature values sensed by said temperature sensor during said second time interval; and (2) estimating said temperature sensor response time constant by fitting said samples of temperature values into an exponential decay/rise time function, said function starting from said first steady state temperature value and attaining said second steady state temperature value according to said temperature sensor response time constant.

According to another aspect of the disclosure, the method further includes the operation of determining a thermal capacitance of said item of cookware through the following steps: (1) determining a time derivative of an external temperature of said item of cookware at a beginning of said first time interval, said external temperature being estimated using said temperature sensor; and (2) estimating a value of said thermal capacitance of said item of cookware as the ratio between said first power and said time derivative.

According to another aspect of the disclosure, a method of regulating a cooking process using an induction cooktop and an item of cookware is provided. The induction cooktop includes (1) a cooking plate on which an item of cookware to be heated is placed upon; (2) an electric heating circuit for induction heating of said item of cookware, said electric circuit being placed underneath said cooking plate; and (3) a temperature sensor placed underneath said cooking plate. The method includes the following method steps: (1) preliminarily determining an induction cooktop gain by performing the method noted above (claim 1); and (2) conducting the cooking process by estimating a temperature on an external surface of said item of cookware only depending upon said induction cooktop gain and a sensed temperature by said temperature sensor installed underneath said induction cooktop surface.

According to another aspect of the disclosure, a method of determining an induction cooktop gain includes the steps of: (1) providing an induction cooktop having a cooking plate on which an item of cookware to be heated is placed, wherein the induction cooktop further includes an electric heating circuit disposed underneath said cooking plate for induction heating of said item of cookware, and further wherein the induction cooktop include a temperature sensor placed underneath said cooking plate, wherein the induction cooktop gain is determined as the ratio between a difference between an external temperature of said item of cookware and a reference temperature, and a difference between a temperature sensed by said temperature sensor at a present time and said reference temperature; (2) placing said item of cookware on said cooking plate, wherein said item of cookware includes a volume of water; (3) powering said electric heating circuit with a first power level for a first time interval to heat said item of cookware until the water boils, wherein said first time interval is determined so as said temperature sensor senses a first steady state temperature value; (4) after said first time interval, powering said electric heating circuit with a second power level for a second time interval to heat said item of cookware to keep the water in a boiling condition, wherein said second time interval is determined so as said temperature sensor attains a second steady state temperature value; and (5) determining, as a function of said first steady state temperature value and of said second steady state temperature value, said induction cooktop gain.

According to yet another aspect of the disclosure, a method of regulating a cooking process using an induction cooktop and an item of cookware is provided, wherein the induction cooktop comprises: (1) a cooking plate on which an item of cookware to be heated is placed upon; (2) an electric heating circuit for induction heating of said item of cookware, said electric circuit being placed underneath said cooking plate; and (3) a temperature sensor placed underneath said cooking plate. The method includes the following method steps: (1) placing said item of cookware on said cooking plate, wherein said item of cookware includes a volume of water; (2) powering said electric heating circuit with a first power level for a first time interval to heat said item of cookware until the water boils, wherein said first time interval is determined so as said temperature sensor senses a first steady state temperature value; (3) after said first time interval, powering said electric heating circuit with a second power level for a second time interval to heat said item of cookware to keep the water in a boiling condition, wherein said second time interval is determined so as said temperature sensor attains a second steady state temperature value; and (4) calculating, as a function of said first steady state temperature value and of said second steady state temperature value, a calculated induction cooktop gain; and (5) conducting said cooking process by estimating a temperature on an external surface of said item of cookware using said calculated induction cooktop gain and a sensed temperature by said temperature sensor.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A method of determining at least one induction cooktop characteristic, wherein said induction cooktop comprises:
a cooking plate on which an item of cookware to be heated is placed;
an electric heating circuit for induction heating of said item of cookware, said electric circuit being placed underneath said cooking plate; and
a temperature sensor placed underneath said cooking plate, wherein said at least one induction cooktop characteristic comprises an induction cooktop gain as the ratio between a difference between an external temperature of said item of cookware and a reference temperature, and a difference between a temperature sensed by said temperature sensor at a present time and said reference temperature;
said method comprising the following steps:
placing said item of cookware, filled at least partially with water, on said cooking plate;
powering said electric heating circuit with a first power for a first time interval to heat by induction said item of cookware as far as the water contained therein boils, wherein said first time interval is determined so as said temperature sensor senses a first steady state temperature value;
after said first time interval, powering said electric heating circuit with a second power for a second time interval heating by induction said item of cookware to keep boiling the water contained therein, wherein said second time interval is determined so as said temperature sensor attains a second steady state temperature value; and
determining, as a function of said first steady state temperature value and of said second steady state temperature value, said induction cooktop gain.

2. The method of claim 1, wherein said second power is less than said first power.

3. The method of claim 2, wherein said second power is one half of said first power.

4. The method of claim 1, wherein said at least one induction cooktop characteristic further comprises a temperature sensor response time constant, said method further comprising the steps of:
collecting samples of temperature values sensed by said temperature sensor during said second time interval; and
estimating said temperature sensor response time constant by fitting said samples of temperature values into an exponential decay/rise time function, said function starting from said first steady state temperature value and attaining said second steady state temperature value according to said temperature sensor response time constant.

5. The method of claim 4, further comprising the operation of determining a thermal capacitance of said item of cookware through the following steps:
determining a time derivative of an external temperature of said item of cookware at a beginning of said first time interval, said external temperature being estimated using said temperature sensor; and
estimating a value of said thermal capacitance of said item of cookware as the ratio between said first power and said time derivative.

6. A method of regulating a cooking process using an induction cooktop and an item of cookware, wherein said induction cooktop comprises:
a cooking plate on which an item of cookware to be heated is placed upon;
an electric heating circuit for induction heating of said item of cookware, said electric circuit being placed underneath said cooking plate; and
a temperature sensor placed underneath said cooking plate;
said method comprising the following method steps:
preliminarily determining an induction cooktop gain by performing the method of claim 1; and
conducting the cooking process by estimating a temperature on an external surface of said item of cookware only depending upon said induction cooktop gain and a sensed temperature by said temperature sensor installed underneath said induction cooktop surface.

7. A method of determining an induction cooktop gain, wherein said method comprises:
providing an induction cooktop having a cooking plate on which an item of cookware to be heated is placed, wherein the induction cooktop further includes an electric heating circuit disposed underneath said cooking plate for induction heating of said item of cookware, and further wherein the induction cooktop include a temperature sensor placed underneath said cooking plate, wherein the induction cooktop gain is determined as the ratio between a difference between an external temperature of said item of cookware and a reference temperature, and a difference between a temperature sensed by said temperature sensor at a present time and said reference temperature;
placing said item of cookware on said cooking plate, wherein said item of cookware includes a volume of water;
powering said electric heating circuit with a first power level for a first time interval to heat said item of cookware until the water boils, wherein said first time interval is determined so as said temperature sensor senses a first steady state temperature value;
after said first time interval, powering said electric heating circuit with a second power level for a second time interval to heat said item of cookware to keep the water in a boiling condition, wherein said second time interval is determined so as said temperature sensor attains a second steady state temperature value; and
determining, as a function of said first steady state temperature value and of said second steady state temperature value, said induction cooktop gain.

8. A method of regulating a cooking process using an induction cooktop and an item of cookware, wherein said induction cooktop comprises:
a cooking plate on which an item of cookware to be heated is placed upon;
an electric heating circuit for induction heating of said item of cookware, said electric circuit being placed underneath said cooking plate; and
a temperature sensor placed underneath said cooking plate;
said method comprising the following method steps:
placing said item of cookware on said cooking plate, wherein said item of cookware includes a volume of water;
powering said electric heating circuit with a first power level for a first time interval to heat said item of cookware until the water boils, wherein said first time interval is determined so as said temperature sensor senses a first steady state temperature value;
after said first time interval, powering said electric heating circuit with a second power level for a second time interval to heat said item of cookware to keep the water in a boiling condition, wherein said second time interval is determined so as said temperature sensor attains a second steady state temperature value; and
calculating, as a function of said first steady state temperature value and of said second steady state temperature value, a calculated induction cooktop gain; and
conducting said cooking process by estimating a temperature on an external surface of said item of cookware using said calculated induction cooktop gain and a sensed temperature by said temperature sensor.
